(19) United States
(12) Patent Application Publication
(10) Pub. No.: US 2009/0283161 A1
(43) Pub. Date: Nov. 19, 2009

(54) Apparatus And Method For Administering Ingestible Liquids

(76) Inventor: Hans Erik Skillrud, Bloomington, IL (US)

Correspondence Address: LAFKAS PATENT LLC, PO Box 43289, CINCINNATI, OH, 45243-0289, US

(21) Appl. No.: 12/121,411

(22) Filed: May 15, 2008

(51) Int. Cl. F16K 11/22

(52) U.S. Cl. 137/606

(57) ABSTRACT

An apparatus for administering ingestible liquids in a serial flow relationship, including a first tubular member having a first diameter, a second tubular member having a second diameter, a hollow intermediate member having a first end, a second end, and a chamber defined therein by an interior surface, and a valve member positioned within the chamber of the intermediate member. The first tubular member is in flow communication with the first end of the intermediate member and the second tubular member is in flow communication with the second end of the intermediate member. The chamber of the intermediate member is divided into first and second portions by the valve member. Accordingly, a first ingestible liquid contained within the first tubular member and a second ingestible liquid contained within the second tubular member are maintained in segregated relation until administration of the first and second ingestible liquids.

### BACKGROUND OF THE INVENTION

The present invention relates generally to an apparatus and method for administering ingestible liquids and, in particular, to an apparatus and method for quickly administering a plurality of ingestible liquids in serial flow relationship without mixing of such liquids.

Various types of containers have been developed for holding more than one ingestible liquid for consumption. One container type involves baby bottles, such as those disclosed in U.S. Pat. No. 5,611,776 to Simmons et al. and U.S. Pat. 6,966,904 to Ruth et al. Another type of container involves certain cup or glass designs, including U.S. Pat. No. 7,165,697 to Checkalski, U.S. Pat. No. 7,108,676 to Loging, and U.S. Pat. No. 6,981,962 to Lenkersdorf. Additional glass designs utilized for consuming alcohol are sold by Quaffers LLC of Tempe, Ariz. Cap devices utilized with containers to switch between different ingestible liquids are disclosed by U.S. Pat. No. 5,984,141 to Gibler and U.S. Pat. No. 6,908,011 to Cho. While the containers disclosed by these patents may be useful for their intended purpose, it will be understood that they do not promote quick consumption, do not segregate the liquids until consumption, do not permit serial consumption (i.e., a first liquid followed by a second liquid), and/or do not permit consumption from the same opening. In the case of the cap devices, certain complex manipulations are also typically required.

Another shortcoming of the aforementioned containers is the action required in order to cause flow of the ingestible liquids for consumption. Generally, such liquid flow is not automatic and certain additional handling is needed. Two devices that do utilize gravity for fluid flow are disclosed in U.S. Pat. No. 7,044,343 to Anue and U.S. Pat. No. 7,185,788 to Morris. In the '343 patent, a device is shown which filters water and therefore only a single liquid is involved. With respect to the '788 patent, the device is for use with a single liquid that is shared simultaneously by several consumers.

Yet another device disclosed in the art is a gravel vacuum cleaner utilized to clean aquariums sold under the trademark of Aqua Culture by Walroart, Inc. While similar in overall design to the apparatus of the present invention, it will be appreciated that the vacuum cleaner relies upon a siphoning action instead of simple gravitational fluid flow. Further, the vacuum cleaner involves the suction of a single liquid which is not intended to be ingested.

Thus, it would be desirable for a device to be developed for use in the administration or ingestion of medicine, alcoholic beverages, vitamins, and/or candy which promotes quick consumption. It would also be desirable for such device to provide segregation or non-mixing of liquids until consumption so that they are ingested in serial flow relation. Yet another desire for the device is that it would provide automatic flow therethrough so that the ingestible liquids could be consumed from a single point.

### BRIEF SUMMARY OF THE INVENTION

In accordance with a first exemplary embodiment of the invention, an apparatus for administering ingestible liquids in a serial flow relationship is disclosed as including a first tubular member having a first diameter, a second tubular member having a second diameter, a hollow intermediate member having a first end, a second end, and a chamber defined therein by an interior surface, and a valve member positioned within the chamber of the intermediate member. The first tubular member is in flow communication with the first end of the intermediate member and the second tubular member is in flow communication with the second end of the intermediate member. The chamber of the intermediate member is divided into first and second portions by the valve member. Accordingly, a first ingestible liquid contained within the first tubular member and a second ingestible liquid contained within the second tubular member are maintained in segregated relation until administration of the first and second ingestible liquids.

In accordance with a second exemplary embodiment of the invention, a method of administering first and second ingestible liquids in a serial flow relationship is disclosed as including the following steps: providing a hollow intermediate member with a first end, a second end, and a chamber defined therein; connecting a first tubular member to the first end of said intermediate member so as to be in flow communication therewith; connecting a second tubular member to the second end of the intermediate member so as to be in flow communication therewith; providing a valve member within the chamber of the intermediate member to control flow of liquid through the chamber, wherein the chamber is defined into first and second portions; loading a first ingestible liquid into the second tubular member through the first tubular member and the intermediate member; manipulating the second tubular member so that the first ingestible liquid resides in the second chamber portion and provides pressure to maintain the valve member in a closed position; loading a second ingestible liquid into the first tubular member and the first chamber portion of the intermediate member; manipulating the second tubular member so that the first ingestible liquid flows therethrough and the valve member is opened so that the second ingestible liquid flows through the intermediate member and the second tubular member is serial flow relationship.

In accordance with a third embodiment of the invention, an apparatus for ingesting first and second ingestible liquids in a serial flow relationship is disclosed as including a tubular member having first and second ends and a valve member positioned within the tubular member, wherein fluid is permitted to flow only in a direction through the tubular member from the second end to the first end.

In accordance with a fourth embodiment of the invention, a method of ingesting first and second liquids in serial flow relationship is disclosed as including the following steps: providing a tabular member with first and second ends; providing a valve member within the tabular member, wherein fluid is permitted to flow only in a first direction through the tubular member; providing a first ingestible liquid in the tubular member; submerging the second end of the tubular member into a container holding a second ingestible liquid therein; drawing the first ingestible liquid and the second ingestible liquid through the first end of the tubular member in serial flow relation.

In accordance with a fifth embodiment of the invention, an apparatus for use with a tubular member in administering ingestible liquids is disclosed as including a hollow member having a first end, a second end, and a chamber defined therein by an interior surface, wherein the first end is adapted to be received by the tubular member so as to be in flow communication therewith and the second end is adapted to receive a fluid therein. A valve member is positioned within the chamber of the hollow member which permits fluid to flow only in a direction through the hollow member from the second end to the first end. A first ingestible liquid may be provided so as to be in flow communication with the first hollow member end and a second ingestible liquid may be provided so as to be in flow communication with the second hollow member end so that the first and second liquids may be consumed in a serial flow relationship.

In accordance with a sixth embodiment of the invention, a method of ingesting first and second liquids in serial flow relationship is disclosed as including the following steps: providing a hollow member having a first end, a second end and a chamber defined therein by an interior surface; positioning a valve member within the chamber of the hollow member, wherein the chamber is divided into first and second portions, the valve member permitting fluid to flow only in a direction through the hollow member from the second end to the first end; providing a first ingestible liquid in flow communication with the first chamber portion of the hollow member; providing a second ingestible liquid in flow communication with the second chamber portion of the hollow member; and, drawing the first and second ingestible liquid through the first end of the hollow member in serial flow relation. The method may included the steps of preloading a predetermined amount of the first ingestible liquid in the first chamber portion and/or preloading a predetermined amount of the second ingestible liquid in the second chamber portion. The method may also include the step of inserting the first hollow member end into an end of a tubular member and providing a predetermined amount of the first ingestible liquid into the tubular member. The method may further include the step of inserting the second hollow member end into an end of a tubular member in flow communication with the second ingestible liquid or positioning the second hollow member end in a container holding the second ingestible liquid therein.

In accordance with a seventh embodiment of the present invention, a hollow container for administering a plurality of ingestible liquids is disclosed as including: a first section having a chamber defined therein by an interior surface, wherein the chamber is configured to hold a predetermined amount of a first ingestible liquid: a second section attachable to the first section having a chamber defined therein by an interior surface, wherein the chamber is configured to hold a predetermined amount of a second ingestible liquid; and, a valve member positioned within the chamber of the first section in order to permit fluid flow only from the chamber of the second section to the chamber of the first section.

In accordance with an eighth embodiment of the present invention, a method of administering a plurality of ingestible liquids in serial flow relationship is disclosed as including the following steps: providing a valve member within a first section of a hollow member, wherein fluid flow is permitted in only a predetermined direction; loading a chamber of the first section of the hollow member with a first ingestible liquid; loading a chamber of a second section of a hollow member with a second ingestible liquid; attaching the first and second sections of the hollow member, wherein the valve member segregates the first and second ingestible liquids when in a closed position; and, drawing the first ingestible liquid from an opening in the first section so that the valve member operates in an open position and the second ingestible liquid flows therethrough in serial flow relation.

### BRIEF DESCRIPTION OF THE DRAWINGS

FIG. 1 is a front elevation view of a first embodiment for an apparatus utilized to administer ingestible liquids in serial flow relationship;

FIG. 2 is an enlarged, partial cross-sectional view of the apparatus depicted in FIG. 1, where a first valve configuration is shown therein;

FIG. 3 is an enlarged, partial cross-sectional view of the apparatus depicted in FIG. 1, where a second valve configuration is shown therein:

FIG. 4 is an enlarged, partial cross-sectional view of the apparatus depicted in FIG. 1, where a third valve configuration is shown therein in the closed position;

FIG. 5 is an enlarged, partial cross-sectional view of the apparatus depleted in FIG. 1 having the third valve configuration of FIG. 4, where the valve is in the open position;

FIG. 6 is an enlarged, partial cross-sectional view of the apparatus depicted in FIG. 1, where a fourth valve configuration is shown therein;

FIG. 7 is a series of diagrammatic views of the apparatus depicted in FIG. 1 during various stages of preparation for administration of ingestible liquids in serial flow;

FIGS. 8 and 9 are a series of diagrammatic views for preparing an inventory system of a plurality of the apparatus depicted in FIG. 1 during various stages, where each, apparatus is preassembled with predetermined and premeasured ingestible liquids stored therein;

FIG. 10 is a diagrammatic view of the inventory system depicted in FIGS. 8 and 9, where the plurality of apparatus has been prepared;

FIG. 11 is a series of diagrammatic views for preparing an apparatus of the inventory system depicted in FIG. 10 for administration of the ingestible liquids stored therein;

FIG. 12 is a series of diagrammatic views of the apparatus depicted in FIG. 1 during various stages of preparing the apparatus for administration of ingestible liquids in serial flow, where an inventory of certain predetermined and premeasured ingestible liquids may be utilized therewith;

FIG. 13 is a cross-sectional view of a second embodiment for an apparatus utilized to administer ingestible liquids in serial flow relationship, where a first ingestible liquid has been pre-loaded therein;

FIG. 14 is a cross-sectional view of the apparatus depicted in FIG. 13, where it has been positioned within a container containing a second ingestible liquid.

FIG. 15 is a cross-sectional view of a third embodiment for an apparatus utilized to administer ingestible liquids in serial flow relationship; and,

FIG. 16 is a cross-sectional view of a fourth embodiment for an apparatus utilized to administer ingestible liquids in serial flow relationship in conjunction with one or more tubular members attached thereto.

### DETAILED DESCRIPTION OF THE INVENTION

Referring now to the drawings in detail, wherein identical numerals indicate the same elements throughout the figures, FIG. 1 depicts a first embodiment of the present invention where an apparatus 10 is useful for administering ingestible liquids in a serial flow relationship or manner. More specifically, apparatus 10 preferably includes a first tubular member 12, a second tubular member 14, a hollow intermediate member 16, and a valve member 18 positioned within intermediate member 16. It will be seen that intermediate member 16 further includes a first end 20, a second end 22, and a chamber 24 defined therein by an interior surface 26. Apparatus 10 is constructed so that first tubular member 12 is in flow communication with first end 20 of intermediate member 16 and second tubular member 14 is in flow communication with second end 22 of intermediate member 16. As shown in FIG. 1, a first ingestible liquid 28 is contained within second tubular member 14 and a second ingestible liquid 30 is contained within first tubular member 12 in segregated relation by means of valve member 18 until administration or consumption thereof.

It will further be appreciated that first tubular member 12, which is preferably substantially rigid, has a first diameter 32. Second tubular member 14, which preferably has at least a predetermined amount of flexibility, has a second diameter 34, where second diameter 34 is preferably less than first diameter 32. Accordingly, intermediate member 16 is preferably configured so that a first portion 36 located adjacent first end 20 thereof is sized to receive first tubular member 12 in a friction fit and a second portion 38 located adjacent, second end 22 thereof is sized to either be inserted into second tubular member 14 (as shown) or receive second tubular member 14 in a friction fit. Because of the difference in diameters 32 and 34 of first and second tubular members 12 and 14, respectively, it will be seen that second portion 38 of intermediate member 16 includes a frustoconical portion 37 to accommodate the reduction in size. Chamber 24 within intermediate member 16 is divided into a first portion 40 and a second portion 42 by valve member 18.

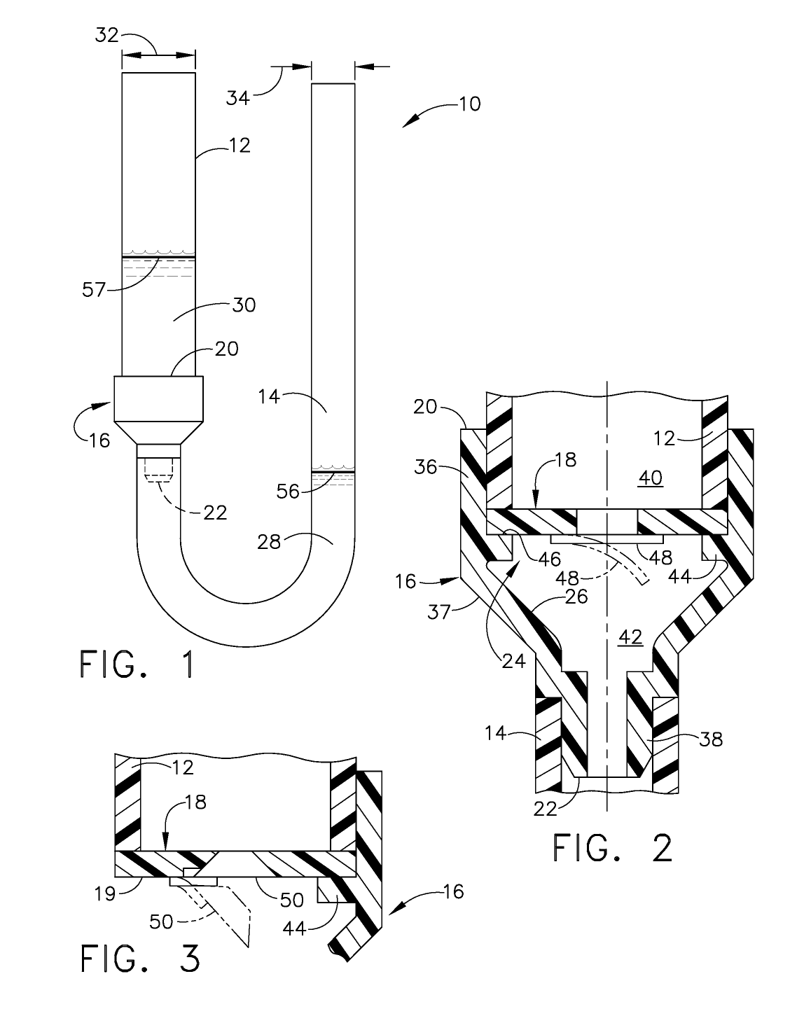

As best seen in FIG. 2, intermediate member 16 preferably includes an inner portion 44 that extends inwardly from interior surface 26 thereof so as to provide an annular surface 46 substantially perpendicular to interior surface 26. Valve member 18 preferably is sized so as to be seated upon annular surface 46, where it may be adhered thereto or maintained in place by means of first-tubular member 12 being positioned thereon. It will be appreciated that annular surface 46 not only functions as a seating surface for valve member 18, but a stop to prevent further insertion of first tubular member 12 into chamber 24 beyond a predetermined point.

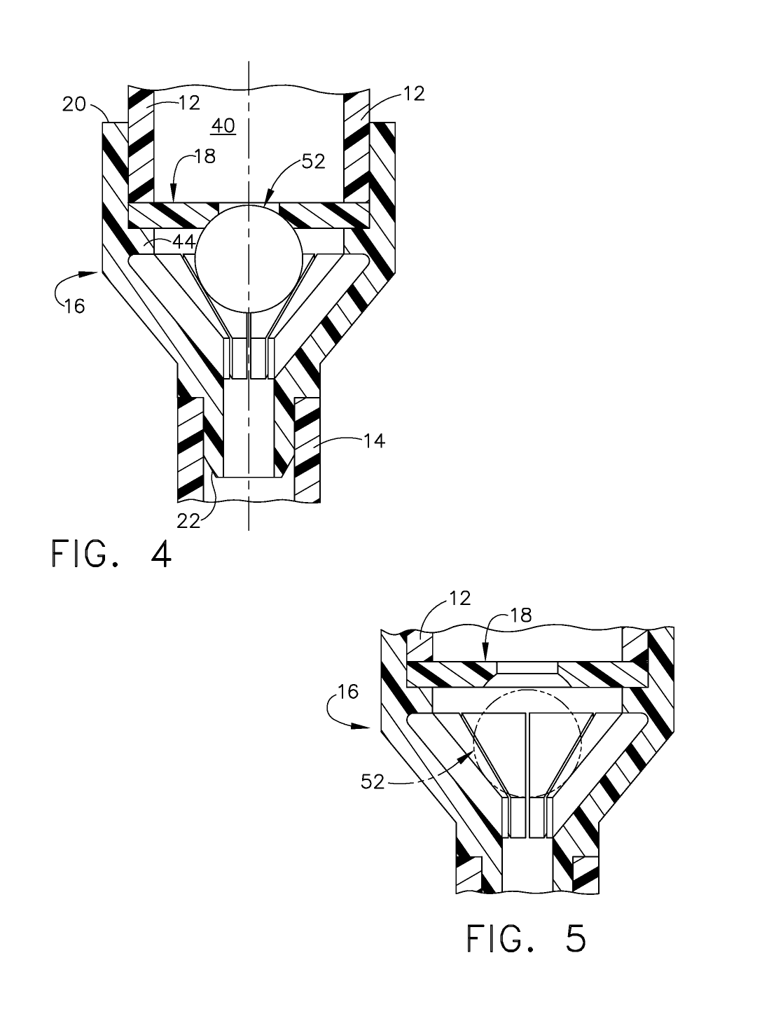

Valve member 18 is preferably maintained in a closed position (shown in solid in FIG. 2) by the pressure of second ingestible liquid 30 within second chamber portion 42. Otherwise, valve member 18 is automatically permitted to move to an open position when the pressure from first ingestible liquid 28 is relaxed or less than a predetermined amount. In particular, valve member 18 may have incorporated therein a flapper valve 48 (see FIG. 2), a hinged valve 50 (see FIG. 3), or a ball valve 52 (see FIGS. 4 and 5) so that it moves automatically from the closed and open positions depending on whether the pressure-of second ingestible liquid 30 within first chamber portion 40 is greater than the pressure provided by first ingestible liquid 28 in second chamber portion 42. Naturally, this will be dependent upon the orientation, position, etc. of second tubular member 14 as discussed in greater detail herein. When valve member 18 is in the open position, then flow of first and second ingestible liquids 28 and 30 is permitted in serial relationship through second tubular member 14. It will further be appreciated that valve member 18 is designed so that flow of liquid occurs only in one direction, i.e., from first chamber portion 40 to second chamber portion 42. This helps to prevent mixing of first and second ingestible liquids 28 and 30. It will further he noted that the valve incorporated within valve member 18 is preferably configured to have beveled surfaces (as seen with hinged valve 50 in FIG. 3) to provide a better seal and enable it to lie even with a bottom surface 19 thereof.

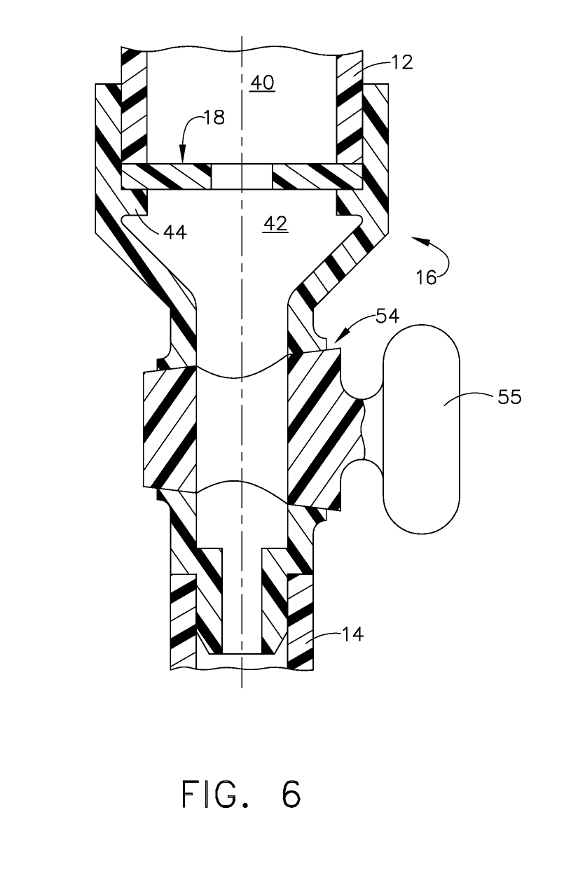

In another alternative embodiment for valve member 18, a cock valve 54 may be incorporated within intermediate member 16 (see FIG. 6). This allows the actuation of such valve 54 from a closed position to an open position to be under mechanical control, thereby requiring a twisting action of a knob 55, for fluid flow therethrough.

It will be recognized that apparatus 10 may allow first and second tubular members 12 and 14 to be detachable from intermediate member 16. Valve member 18 may also be detachable from intermediate member 16. This allows cleaning or rinsing of such components prior to use of apparatus 10 with other ingestible liquids. Of course, some uses of apparatus 10 (e.g., for administration of medicine) may require that it have a single use. In either event, it is preferred that one or more markings, as represented by numerals 56 and 57 (see FIG. 1), be provided on second tubular member 14 and first tubular member 12, respectively, so that a predetermined measurement of first ingestible liquid 28 and second ingestible liquid 30 can be controlled. Such marking 56 may be representative of a typical shot of alcohol, dose of medicine, or the like contained within second tubular member 14 and second chamber portion 42.

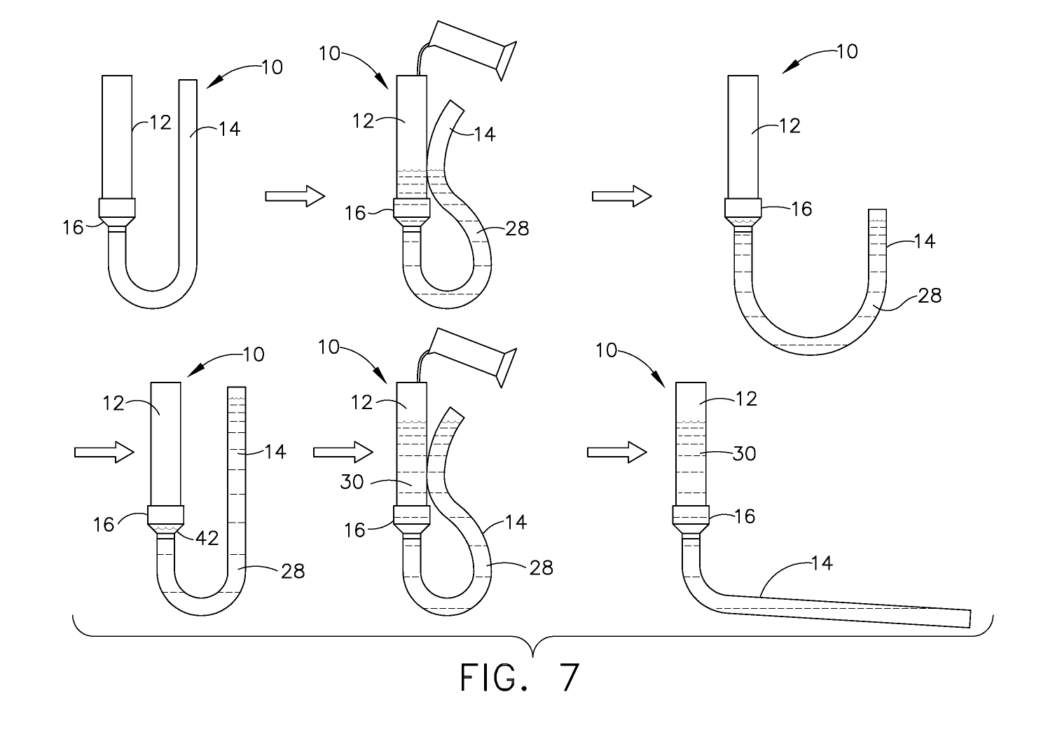

It will also be appreciated that a preferred method of administering first and second ingestible liquids 28 and 30 in a serial flow relationship is associated with apparatus 10. Such method includes the following steps; providing hollow intermediate member 16 with first end 20, second end 22 and chamber 24 defined therein; connecting first tubular member 12 to first end 20 of intermediate member 16; connecting a second tubular member 14 to second end 22 of intermediate member 16; and, providing a valve member 18 within chamber 24 of intermediate member 16 to control flow of liquid within chamber 24, wherein chamber 24 is defined into first and second portions 36 and 38, respectively. The construction of such components into apparatus 10 is shown as the first stage in FIG. 7. Thereafter, first ingestible liquid 28 is loaded into second tubular member 14 through first tubular member 12 and intermediate member 16 (second stage in FIG. 7) and second tubular member 14 is manipulated so that first ingestible liquid 28 resides in second chamber portion 38 and provides pressure to maintain valve member 18 in a closed position (third and fourth stages of FIG. 7). Second ingestible liquid 30 is then loaded into first tubular member 12 and first chamber portion 36 of intermediate member 16 to finish preparation of apparatus 10 (fifth stage of FIG. 7). In order to open valve member 18, second tubular member 14 is manipulated so that first ingestible liquid 28 flows therethrough (sixth stage of FIG. 7). This releases the pressure on valve member 18 so that second ingestible liquid 30 flows through intermediate member 16 and second tubular member 14 in serial flow relationship with first ingestible liquid 28.

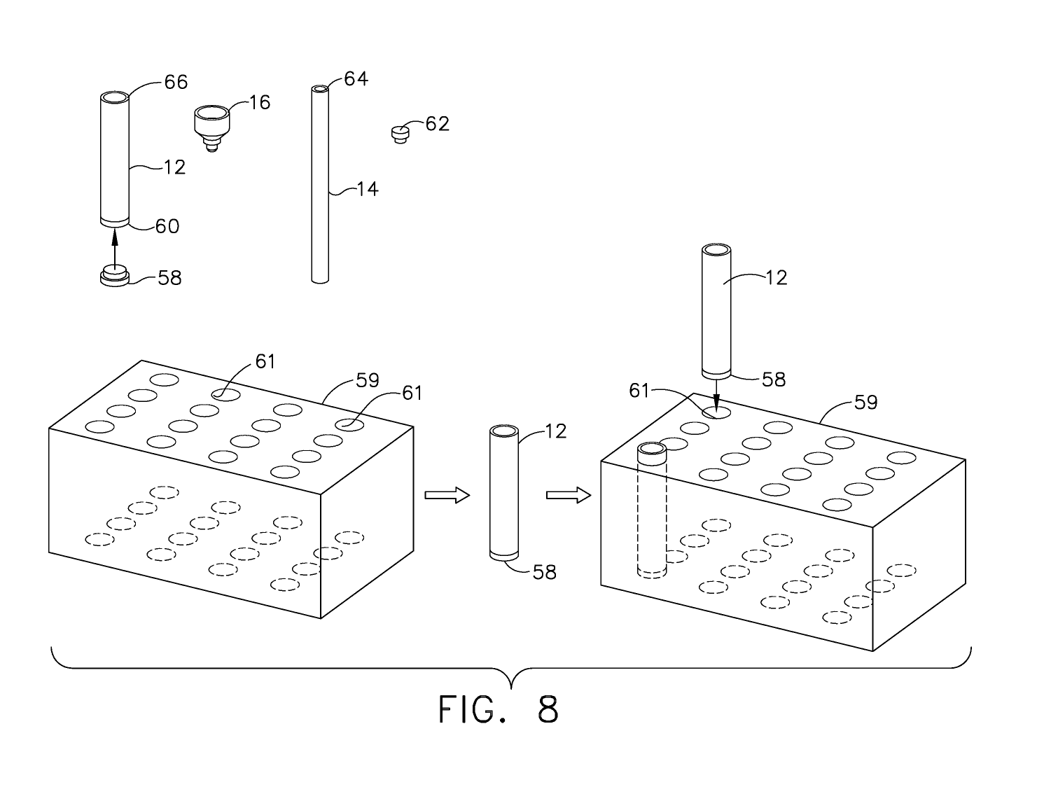

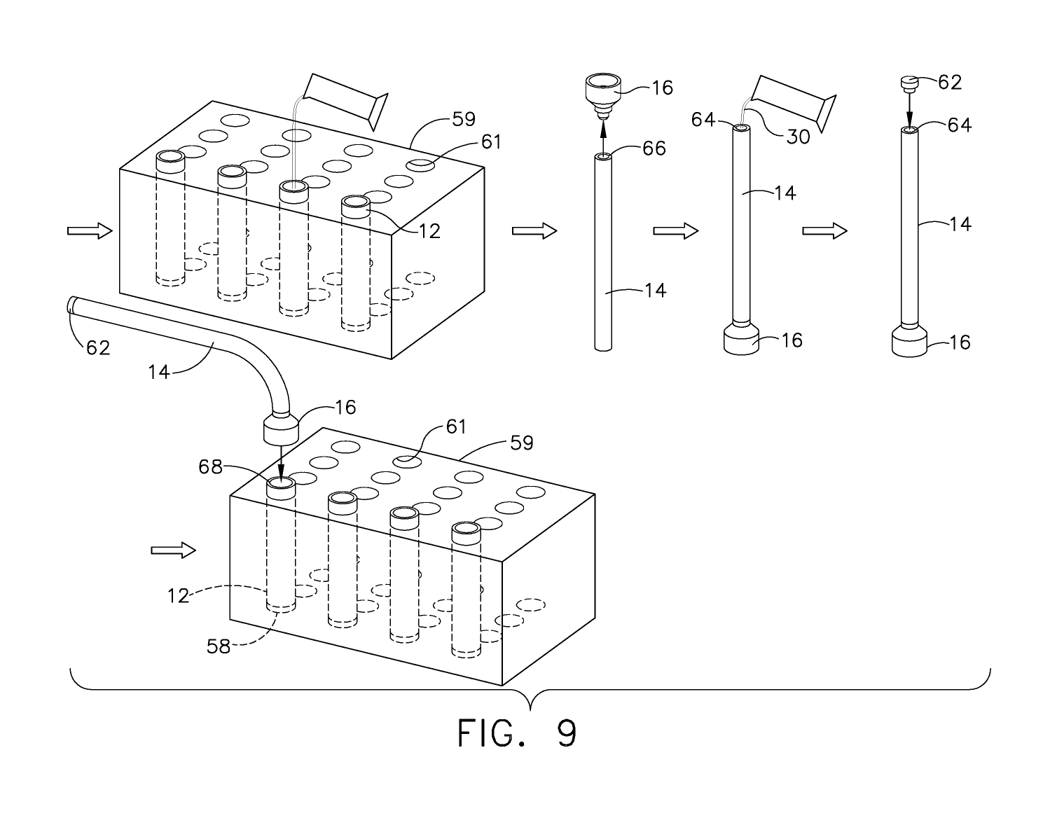

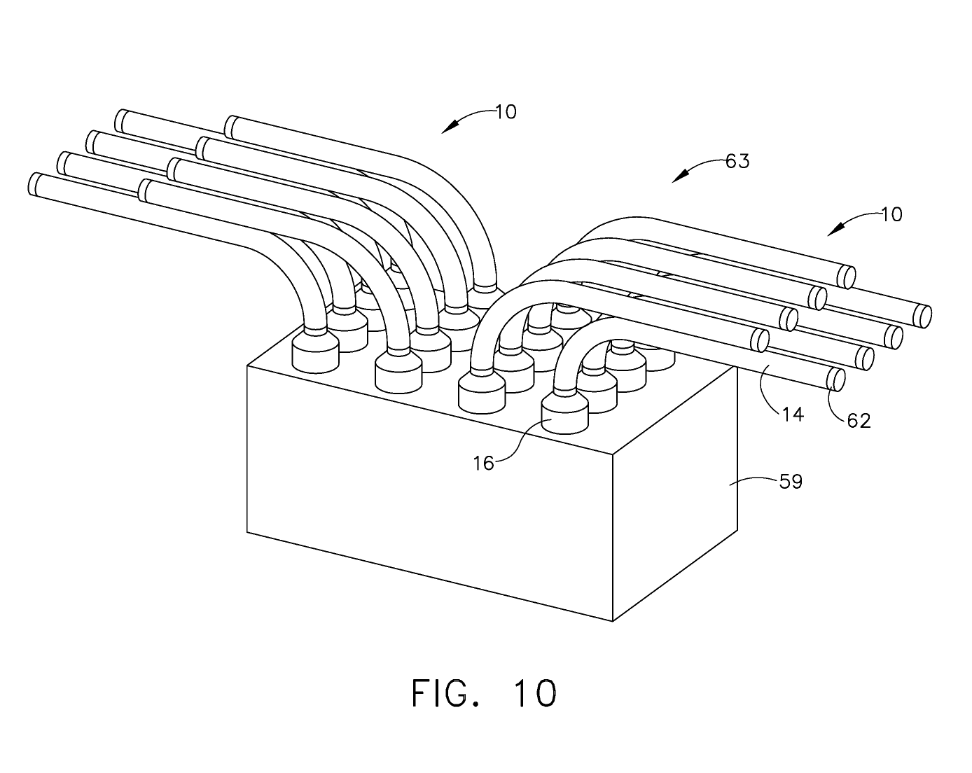

In order to provide a preloaded apparatus 10 suitable for inventory purposes, alternative steps in the method may include providing a customized container 59 including a plurality of openings 61 therein sized to accommodate apparatus 10 (stage 1 in FIG. 8), providing a cap 58 on a first or open end 60 of first tubular member 12 (stage 2 in FIG. 8), inserting first tubular member 12 into an opening 61 in container 59 (stage 3 in FIG. 8) and preloading second ingestible liquid 30 in first tubular member 12 (stage 1 in FIG. 9). Valve member 18 is then preferably connected to a second end 66 of second tubular member 14 (stage 2 in FIG. 9) so that first ingestible liquid 28 can be preloaded in second tubular member 14 (stage 3 in FIG. 9) before connecting a cap 62 to a first or open end 64 of second tubular member 14 (stage 4 in FIG. 9). Of course, a second end 68 of first tubular member 12 is able to then be connected to first end 20 of intermediate member 16 (stage 5 in FIG. 9). It will be seen in FIG. 10 that a complete inventory 63 of apparatuses 10 are provided which are preloaded and ready for use.

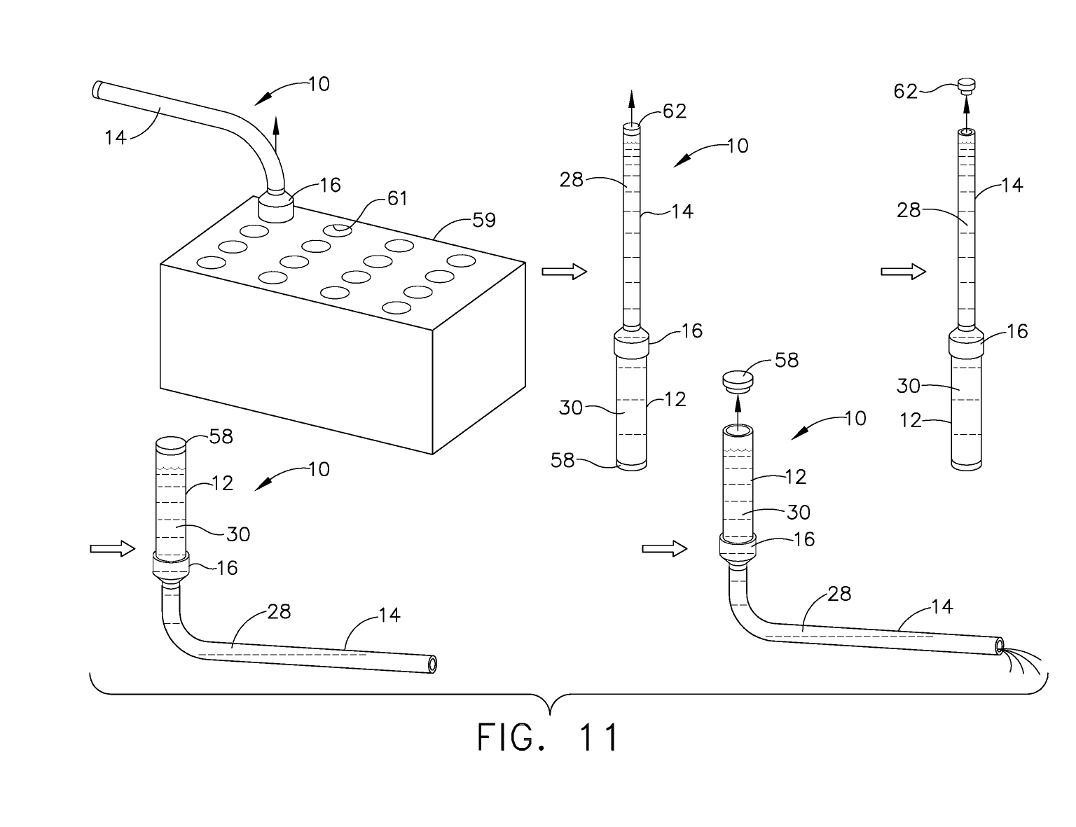

In order to consume first and second ingestible liquids 28 and 30 from an apparatus 10 in inventory 63, an apparatus 10 is selected and removed from container 59 (stage 1 in FIG. 11). Thereafter, apparatus 10 is oriented substantially linearly (in the vertical direction) so that first tubular member 12 is located below second tubular member 14 (stage 2 in FIG. 11), whereupon cap 62 is removed from first end 64 (stage 3 in FIG. 11). Apparatus 10 is then repositioned with first tubular member 12 on top (in a relatively vertical position) and second tubular member 14 is therebelow and curved substantially perpendicular thereto (in a relatively horizontal position) (stage 4 in FIG. 11). This positions apparatus 10 in a manner which permits gravity to influence flow of first and second ingestible liquids 28 and 30 therethrough. Cap 58 is removed from first end 60 of first tubular member 12, and first and second ingestible liquids 28 and 30 flow through second tubular member 14.

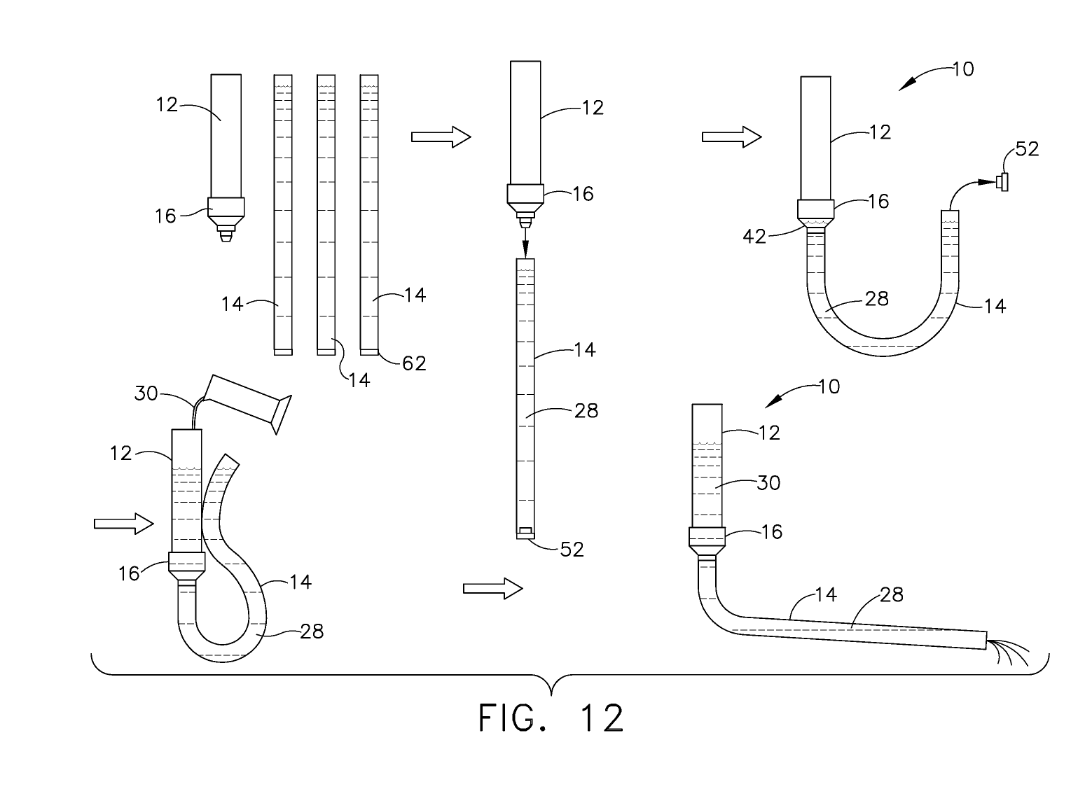

It will also be seen from FIG. 12 that a plurality of preloaded second tubular members 14 may be utilized with a first tubular member 12 connected to intermediate member 16 (stage 1 in FIG. 12). As seen therein, a second tubular member 14 is selected to be connected to second end 22 of intermediate member 16 (stage 2 in FIG. 12). Second tubular member 14 is then manipulated into a desired position where first end 64 thereof is raised until first ingestible liquid 28 enters second chamber portion 42 in intermediate member 16 and provides the pressure necessary to maintain valve member 18 in the closed position and cap 62 is removed (stage 3 in FIG. 12). Second ingestible liquid 30 is then provided into first tubular member 12 to a desired level (stage 4 in FIG. 12), whereupon second tubular member 14 is brought into a substantially horizontal position so that first and second ingestible liquids 28 and 30 are able to flow therethrough.

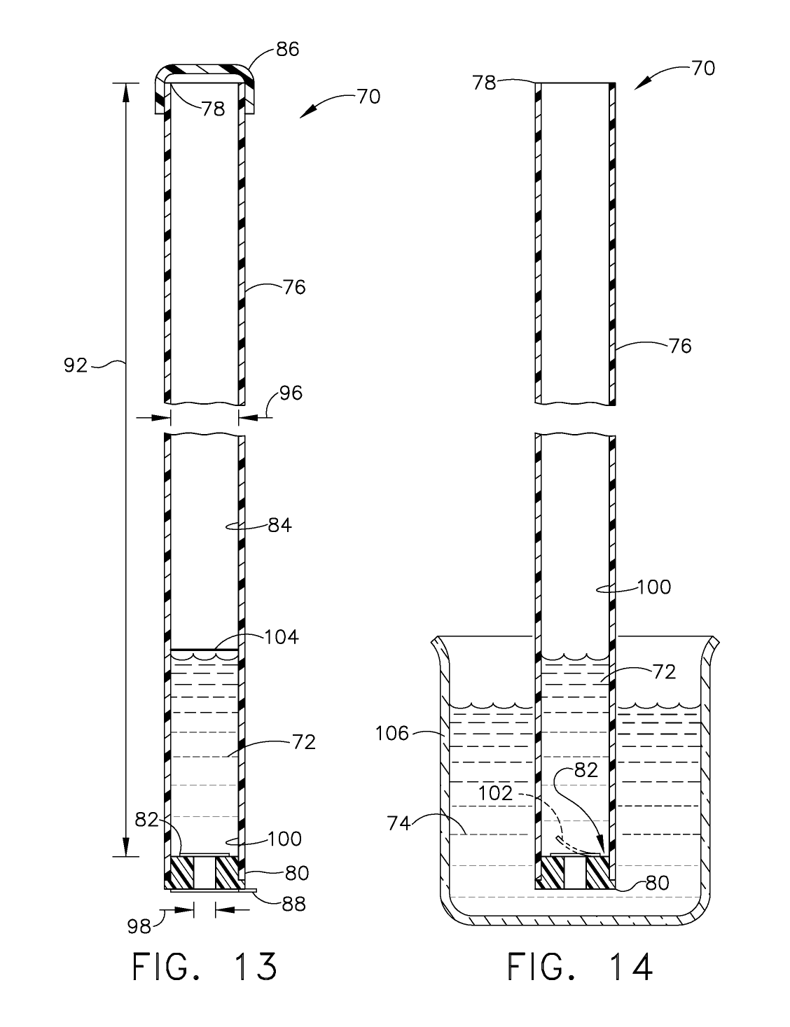

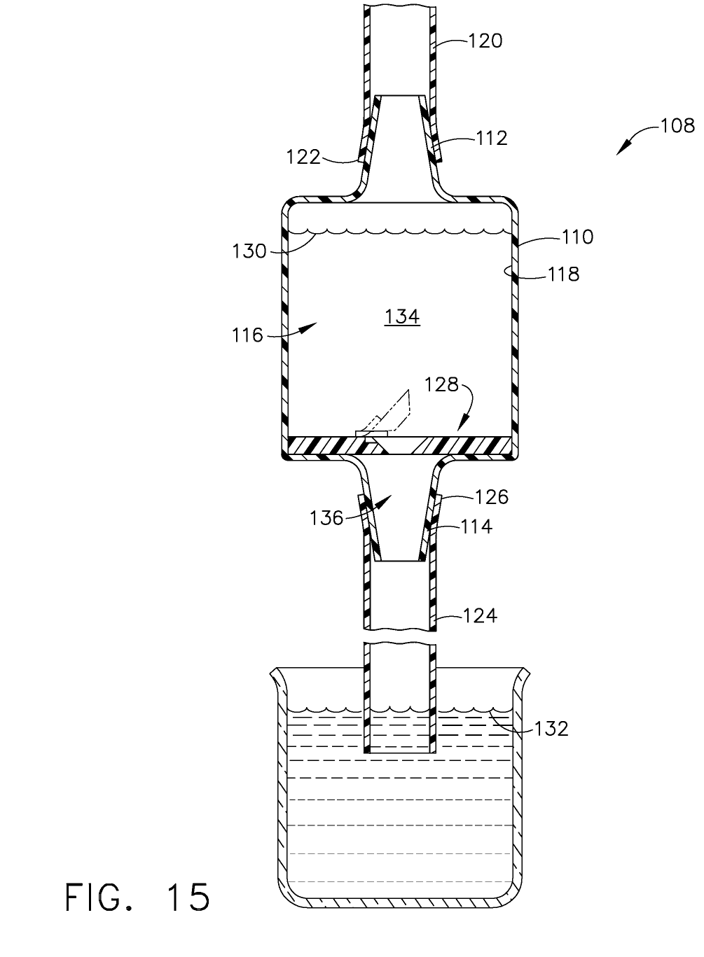

A second embodiment of the invention is depicted in FIGS. 13 and 14, where an apparatus 70 for ingesting first and second ingestible liquids 72 and 74 in a serial flow relationship is shown. It will be seen that apparatus 70 preferably includes a tubular member 76 having first and second ends 78 and 80, respectively. A valve member 82 is positioned within tubular member 76 so that fluid is permitted to flow only in a direction through tubular member 76 from second end 80 to first, end 78. Further, if will be appreciated that first ingestible liquid 72 is either stored in a premeasured amount or otherwise contained within a first portion 84 of tubular member 76 located above valve member 82. In order to keep apparatus 10 in a desired condition prior to use, a removable cap 86 may be positioned over first end 78 of tubular member 76 and/or a removable protective member 88 may be positioned over second end 80 of tubular member 76.

It will be noted that a flow path through tubular member 76 is divided into first portion 84 on a first side of valve member 82 and a second portion on a second side of valve member 82. Since valve member 82 is preferably positioned adjacent second end 80 of tubular member 76 (see FIG. 13), there may not be a second portion but first portion 84 of tubular member 76 preferably has a greater length 92 than any second portion nevertheless. Also, it is preferred that a flow path 96 of first portion 84 have a greater cross-sectional area than a flow path 98 through valve member 82. Depending upon the placement of valve member 82 within tubular member 76, the relative lengths of first and second portions 84 and 90, respectively, may be altered.

Valve member 82 may be adhered to an inner surface 100 of tubular member 76 or otherwise be sized so as to provide a friction fit therewith. It will be understood that valve member 82 is maintained in a closed position by the pressure of first ingestible liquid 72 within flow path 96 of first tubular member portion 84. Valve member 82 is permitted to move to an open position when pressure from first ingestible liquid 72 within flow path 96 is relaxed, such as by a sucking action on first end 78 of tubular member 76. As described with respect to the first embodiment, valve member 82 preferably has a flapper valve 102 incorporated therein, although a hinged valve, ball valve or any other type valve allowing flow in one direction may be utilized. Of course, it is preferred that valve member 82 operates so that any valve incorporated therein moves between a closed position and an open position automatically (i.e., without mechanical actuation).

Tubular member 76 preferably has a predetermined amount of flexibility and may include an area (not shown) which enables even greater flexibility so that tubular member 76 may be bent at such area. In order to identify an amount of first ingestible liquid 72 contained within flow path 96 of first portion 84 within tubular member 76, at least one marking 104 is preferably provided thereon. Apparatus 70 may be washed and reused as desired.

It will be seen in FIG. 14 that apparatus 70 is preferably utilized with a container 106 which has second ingestible liquid 74 therein. Container 106 may be of any size and include any amount of second ingestible liquid 74, so long as second end 80 of tubular member 76 is positioned or submerged therein (after protective cover 88 is removed therefrom). The pressure on valve member 82 from first ingestible liquid 72 maintains it in the closed position until first ingestible liquid 72 is drawn through first end 78 of tubular member 76. As this occurs, valve member 82 goes to the open position and allows second ingestible liquid 74 to follow first ingestible liquid 72 through first end 78 in serial relationship.

In conjunction with apparatus 70, a method of ingesting first and second liquids 72 and 74 in serial flow relationship is provided which includes the following steps: providing tubular member 76 with first and second ends 78 and 80; providing valve member 82 within tubular member 76, wherein fluid is permitted to flow only in a first direction through tubular member 76: providing first ingestible liquid 72 in tubular member 76; submerging second end 80 of tubular member 76 into a container 106 holding second ingestible liquid 74 therein; and, drawing first ingestible liquid 72 and second ingestible liquid 74 through first end 78 of tubular member 76 in serial flow relation. The method may also include the steps of removing cap 86 positioned over tubular member first end 78 and/or removing protective member 88 positioned over tubular member second end 80. Additionally, the method preferably includes the step of affixing valve member 82 to an interior surface 100 of tubular member 76 and preferably locating such valve member 82 adjacent second end 80 of tubular member 76. The method also preferably includes the step of preloading a predetermined amount of first ingestible liquid 72 in tubular member 76.

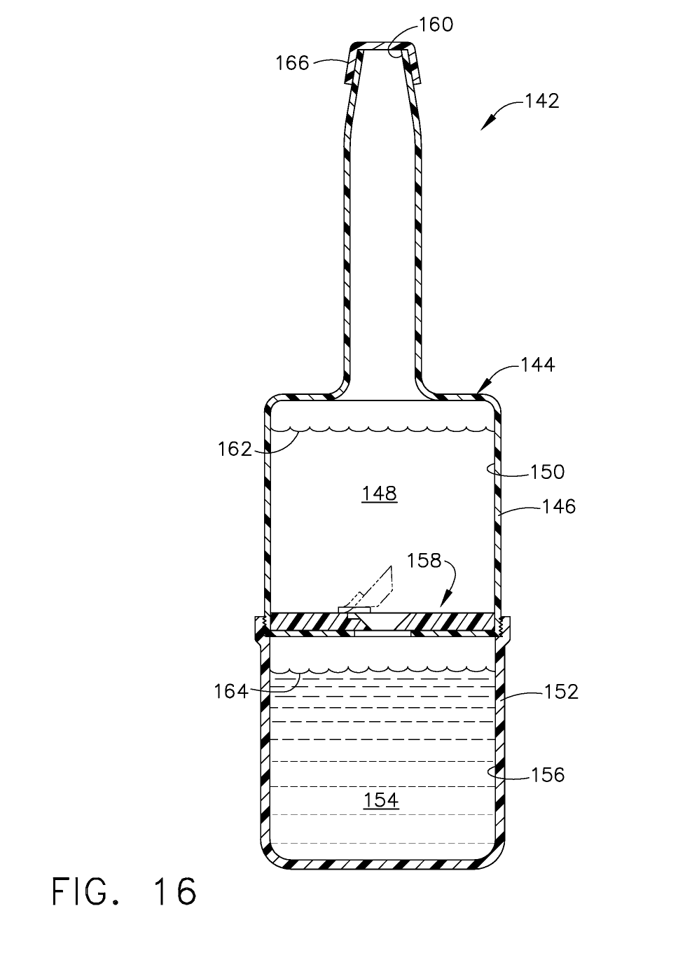

In a third embodiment of the present invention, an apparatus 108 for use in administering ingestible liquids in serial flow relation is shown in FIG. 15. Apparatus 108 includes a hollow member 110 having a first end 112, a second end 114, and a chamber 116 defined therein by an interior surface 118. It will further be seen that first end 112 of hollow member 110 is preferably adapted to be received by a first tubular member 120 at an end 122 thereof so as to be in flow communication therewith. Second end 114 of hollow member 110 may also be adapted to be received by a second tubular member 124 at an end 126 thereof or merely be adapted receive a fluid directly therein. A valve member 128 is preferably positioned within chamber 116 of hollow member 110 which permits fluid to flow only in a direction through hollow member 110 from second end 114 to first end 112. In this way, a first ingestible liquid 130 may be provided to first tubular member 120 and a second ingestible liquid 132 may be provided so as to be in flow communication with second end 114 of hollow member 110 so that first and second ingestible liquids 130 and 132 maybe consumed in a serial flow relationship.

More specifically, it will be seen that valve member 128 divides chamber 116 in hollow member 110 into a first portion 134 adjacent first end 112 and a second portion 136 adjacent second end 114. Valve member 128 is constructed so that it preferably is maintained in a closed position by the pressure of first ingestible liquid 130 within first chamber portion 134. Once the pressure from first ingestible liquid 130 is eased to below a predetermined level, such as when it begins flowing out first end 112, then valve member 128 is permitted to move to an open position so that second ingestible liquid 132 flows therethrough in serial relationship. Accordingly, it is preferred that valve member 128 operate between a closed position and an open position automatically.

It will be appreciated that first chamber portion 134 may be sized to hold a predetermined amount of first ingestible liquid 130 (e.g., a shot, dose, or other desired amount). Such first ingestible liquid 130 may be preloaded in first chamber portion 134 or provided thereto prior to consumption via first tubular member 120 or first end 112 of hollow member 110. A cap (not shown) may be provided to first end 112 of hollow member 110 to protect the contents of first chamber portion 134. Similarly, a cap (not shown) may be positioned on second end 136 of hollow member 110 until it is ready to have second tubular member 124 attached thereto or it is positioned within a container filled with second ingestible liquid 132 (as in FIG. 14).

Yet another embodiment of the invention is apparatus 142 shown in FIG. 16, which is a hollow container 144 having a first section 146 that is open to a chamber 148 therein defined by an interior surface 150. Hollow container 144 preferably includes a second section 152, which is attachable or connectable to first section 146 (e.g., via threads, snaps, etc.), that has a chamber 154 therein defined by an interior surface 156. A valve member 158 is preferably positioned within chamber 148 or chamber 154 in order to permit fluid flow in a single direction from chamber 154 to chamber 148. It will be seen that first section 146 includes an opening 160 therein which permits flow communication with first section 146, as well as second section 152 when valve member 158 is in an open position. A cap 166 may be positioned over opening 160. It will be appreciated that first section 146 is preferably loaded with a first ingestible liquid 162 and second section 152 is loaded with a second ingestible liquid 164 so that they may be ingested or consumed in serial flow relationship through opening 160 when valve member 158 is in an open position. Otherwise, valve member 158 prevents second ingestible liquid 164 from entering chamber 148 of first section 146 when in the closed position.

It is preferred that a chamber 148 be sized and configured so as to permit a predetermined amount of first ingestible liquid 162 to be provided thereto and that chamber 154 be sized and configured so as to permit a predetermined amount of second ingestible liquid 164 to be provided therein. It is also preferred that first section 146 of hollow container be shaped so that if is aesthetically pleasing when positioned for consumption of first and second ingestible liquids 162 and 164 therein. Since first and second sections 146 and 152 are attachable and detachable, hollow container 144 may be refilled with liquids and reused.

With regard to specific uses of apparatuses 10, 70, 108 and 142 described herein, it will be appreciated that the liquids provided for administration or consumption are preferably ingestible by humans. In one such use, the first ingestible liquid will be a type of alcohol and the second ingestible liquid is a mixer or a chaser liquid. This permits the alcohol to be consumed, with a chaser liquid having a sweeter or more pleasing taste following quickly in serial relationship. Accordingly, the consumer is left with the taste of the second or chasing liquid.

Another use of apparatuses 10, 70, 108 and 142 may involve the administration of certain medicine which may have an unpleasant taste. By using such medicine as the first ingestible liquid in the prescribed amount, the chasing liquid is able to also provide a more pleasant, aftertaste. This is particularly effective for infants, children and other patients that are unable to swallow pills. Vitamins and other supplements may be administered in like manner.

Yet another contemplated use of apparatuses 10, 70, 108 and 142 involves the consumption of candy or other sweets. It has become fashionable, for example, to provide such products which have a combination of a sweet tasting portion and a sour portion. Thus, depending upon which type a person prefers, the first ingestible liquid may have a sour or sweet taste, with the second ingestible liquid having the opposite type flavor. Another possibility is that the product merely has two different flavors, whether they are both sweet, both soar, or some combination.

Having shown and described the preferred embodiment of the present invention, further adaptations of the apparatuses for administering or ingesting liquids in a serial flow relationship, or the methods pertaining to such apparatuses, may be made by one skilled in the art and are contemplated by the present invention. Indeed, other uses than those illustrated herein, as well as the various ingestible liquids administered or consumed, may also be made.

What is claimed is:

1. An apparatus for administering ingestible liquids in a serial flow relationship, comprising:
(a) a first tubular member having a first diameter;
(b) a second tubular member having a second diameter;
(c) a hollow intermediate member having a first end, a second end, and a chamber defined therein by an interior surface, said first tubular member being in flow communication with said first end thereof and said second tubular member being in flow communication with said second end thereof; and,
(d) a valve member positioned within said chamber of said intermediate member, wherein said chamber is divided into first and second portions;
wherein a first ingestible liquid contained within said first tubular member and a second ingestible liquid contained within said second tubular member are maintained in segregated relation until administration of said first and second ingestible liquids.

2. The apparatus of claim 1, said intermediate member first end being sized to receive a portion of said first tubular member.

3. The apparatus of claim 1, said intermediate member second end being sized to be receivable by a portion of said second tubular member.

4. The apparatus of claim 1, said intermediate member further comprising an inner portion extending inwardly about the periphery of said inner surface thereof.

5. The apparatus of claim 4, wherein said valve member is adhered in position on a surface of said inner portion.

6. The apparatus of claim 4, wherein said first tubular member is positioned within said chamber of said intermediate member so as to maintain said valve member on a surface of said inner portion.

7. The apparatus of claim 1, wherein said valve member is maintained in a closed position by the pressure of said second ingestible liquid within said second chamber portion.

8. The apparatus of claim 7, wherein said valve member is permitted to move to an open position when pressure from said second ingestible liquid within said second chamber portion is less than a predetermined amount.

9. The apparatus of claim 1, wherein said valve member operates so that a valve operates between a closed position and an open position automatically.

10. The apparatus of claim 1, wherein said valve member so that a valve operates between a closed position and an open position by a mechanical control.

11. The apparatus of claim 1, wherein said first tubular member is substantially rigid.

12. The apparatus of claim 1, wherein said second tubular member has a predetermined amount of flexibility.

13. The apparatus of claim 1, wherein said first ingestible liquid is maintained in said first chamber portion and said second ingestible liquid is maintained in said second chamber portion when said valve member is in a closed position.

14. The apparatus of claim 1, wherein said first ingestible liquid and said second ingestible liquid flow in serial relationship through said second tubular member when said valve member is in an open position.

15. The apparatus of claim 1, wherein said valve member allows liquid to flow only in a direction from said first chamber portion to said second chamber portion.

16. The apparatus of claim 1, wherein said first tubular member includes at least one marking thereon to indicate a predetermined amount of liquid contained therein.

17. The apparatus of claim 1, wherein said second tubular member includes at least one marking thereon to indicate a predetermined amount of liquid contained therein.

18. A method of administering first and second ingestible liquids in a serial flow relationship, comprising the following steps:
(a) providing a hollow intermediate member with a first end, a second end, and a chamber defined therein;
(b) connecting a first tubular member to said first end of said intermediate member so as to be in flow communication therewith;
(c) connecting a second tubular member to said second end of said intermediate member so as to be in flow communication therewith;
(d) providing a valve member within said chamber of said intermediate member to control flow of liquid through said chamber, wherein said chamber is defined into first and second portions;
(e) loading a first ingestible liquid into said second tubular member through said first tubular member and said intermediate member;
(f) manipulating said second tubular member so that said first ingestible liquid resides in said second chamber portion arid provides pressure to maintain said valve member in a closed position;
(g) loading a second ingestible liquid into said first tubular member and said first chamber portion of said intermediate member; and,
(h) manipulating said second tubular member so that said first ingestible liquid flows therethrough and said valve member is opened so that said second ingestible liquid flows through said intermediate member and said second tubular member in serial flow relationship.

19. The method of claim 18, further comprising the following steps:
(a) providing a cap on a first end of said first tubular member: and,
(b) preloading said second ingestible liquid in said first tubular member.

20. The method of claim 19, further comprising the following steps:
(a) providing a cap on a first end of said second tubular member;
(b) preloading said first ingestible liquid in said second tubular member; and,
(c) connecting a second end of said second tubular member to said second end of said intermediate member.

21. The method of claim 20, further comprising the step of connecting a second end of said first tubular member to said first end of said intermediate member.

22. The method of claim 21, further comprising the following steps:
(a) orienting said first tubular member in a substantially vertical position with said intermediate member positioned therebelow;
(b) orienting said second tubular member so that said first end thereof is positioned below said intermediate member; and,
(c) removing said cap on said first end of said second tubular member.

23. An apparatus for ingesting first and second ingestible liquids in a serial flow relationship, comprising:
(a) a tubular member having first and second ends; and,
(b) a valve member positioned within said tubular member, wherein fluid is permitted to flow only in a direction through said tubular member from said second end to said first end.

24. The apparatus of claim 23, wherein said first ingestible liquid is contained within said tubular member.

25. The apparatus of claim 24, further comprising a cap positioned over said tubular member first end.

26. The apparatus of claim 23, further comprising a removable protective member over said tubular member second end.

27. The apparatus of claim 23, wherein a flow path through said tubular member is smaller in cross-section that a flow path through said valve member.

28. The apparatus of claim 23, wherein a premeasured amount of said first ingestible liquid is stored within said tubular member.

29. The apparatus of claim 23, wherein said valve member is adhered to an inner surface of said tubular member.

30. The apparatus of claim 23, wherein said valve member is maintained in a closed position by the pressure of said first ingestible liquid within a first portion of said tubular member flow path.

31. The apparatus of claim 30, wherein said valve member is permitted to move to an open position when pressure from said first ingestible liquid within said first portion of said tubular member flow path is less than a predetermined amount.

32. The apparatus of claim 23, wherein said valve member operates between a closed position and an open position automatically.

33. The apparatus of claim 23, wherein said tubular member includes at least one marking thereon to indicate a predetermined amount of said first ingestible liquid contained therein.

34. A method of ingesting first and second liquids in serial flow relationship, comprising the following steps:
(a) providing a tubular member with first and second ends;
(b) providing a valve member within said tubular member, wherein fluid is permitted to flow only in a first direction through said tabular member;
(c) providing a first ingestible liquid in said tubular member;
(d) positioning said second end of said tubular member so as to be in flow communication with a container holding a second ingestible liquid therein;
(e) drawing said first ingestible liquid and said second ingestible liquid through said first end of said tubular member in serial flow relation.

35. The method of claim 34, further comprising the step of removing a cap positioned over said tubular member first end.

36. The method of claim 34, further comprising the step of removing a protective member positioned over said tubular member second end.

37. The method of claim 34, further comprising the step of affixing said valve member to an inner surface of said tubular member.

38. An apparatus for use with a tubular member in administering ingestible liquids, comprising:
(a) a hollow member having a first end, a second end, and a chamber defined therein by an interior surface, wherein said first end is adapted to be received by said tubular member so as to be in flow communication therewith and said second end is adapted to receive a fluid therein; and,
(b) a valve member positioned within said chamber of said hollow member which permits fluid to flow only in a direction through said hollow member from said second end to said first end;
wherein a first ingestible liquid may be provided so as to be in flow communication with said first hollow member end and a second ingestible liquid may be provided so as to be in flow communication with said second hollow member end so that said first and second liquids may be consumed in a serial flow relationship.

39. The apparatus of claim 38, said valve member dividing said chamber in said hollow member into first and second portions,

40. The apparatus of claim 39, wherein said valve member is maintained in a closed position by the pressure of said first ingestible liquid within said first chamber portion.

41. The apparatus of claim 40, wherein said valve member is permitted to move to an open position when pressure from said first ingestible liquid within said first chamber portion is less than a predetermined amount.

42. The apparatus of claim 38, wherein said valve member operates between a closed position and an open position automatically.

43. The apparatus of claim 39, wherein said first chamber portion of said hollow member is sized to contain a predetermined amount of liquid.

44. The apparatus of claim 38, further comprising a protective member over said hollow member second end.

45. The apparatus of claim 38, further comprising a cap over said hollow member first end.

46. The apparatus of claim 39, further comprising a predetermined amount of said first ingestible liquid preloaded in said first chamber portion.

47. The apparatus of claim 38, wherein said second end of said hollow member is adapted to be received by a second tubular member.

48. The apparatus of claim 47, further comprising a cap over said hollow member second end.

49. The apparatus of claim 39, wherein said second end of said hollow member is closed and a predetermined amount of said second ingestible liquid is preloaded in said second chamber portion.

50. A method of ingesting first and second liquids in serial flow relationship, comprising the following steps:
(a) providing a hollow member having a first end, a second end and a chamber defined therein by an interior surface:
(b) positioning a valve member within said chamber of said hollow member, wherein said chamber is divided into first and second portions, said valve member permitting fluid to flow only in a direction through said hollow member from said second end to said first end:
(c) providing a first ingestible liquid in flow communication with said first chamber portion of said hollow member;
(d) providing a second ingestible liquid in flow communication with said second chamber portion of said hollow member; and,
(e) drawing said first and second ingestible liquid through said first end of said hollow member in serial flow relation.

51. The method of claim 50, further comprising the step of preloading a predetermined amount of said first ingestible liquid in said first chamber portion.

52. The method of claim 50, further comprising the step of preloading a predetermined amount of said second ingestible liquid in said second chamber portion.

53. The method of claim 50, further comprising the step of inserting said first hollow member end into an end of a tubular member.

54. The method of claim 50, further comprising the step of inserting said second hollow member end into an end of a tubular member in flow communication with said second ingestible liquid.

55. The method of claim 50, further comprising the step of positioning said second hollow member end in a container holding said second ingestible liquid therein.

56. The method of claim 53, further comprising the step of providing a predetermined amount of said first ingestible liquid into said tubular member.

57. The method of claim 50, further comprising the step of configuring said first hollow member end so as to have a predetermined size and shape.

58. A hollow container for administering a plurality of ingestible liquids, comprising:
(a) a first section having a chamber defined therein by an interior surface, wherein said chamber is configured to hold a predetermined amount of a first ingestible liquid;
(b) a second section attachable to said first section having a chamber defined therein by an interior surface, wherein said chamber is configured to hold a predetermined amount of a second ingestible liquid; and,
(c) a valve member positioned within said chamber of said first section in to permit fluid flow only from said chamber of said second section to said chamber of said first section.

59. A method of administering a plurality of ingestible liquids in serial flow relationship, comprising the following steps:
(a) providing a valve member within a first section of a hollow member, wherein fluid flow is permitted in only a predetermined direction;
(b) loading a chamber of said first section of said hollow member with a first ingestible liquid;
(c) loading a chamber of a second section of a hollow member with a second ingestible liquid;
(d) attaching said first and second sections of said hollow member, wherein said valve member segregates said first and second ingestible liquids when in a closed position; and,
(e) drawing said first ingestible liquid from an opening in said first section so that said valve member operates in an open position and said second ingestible liquid flows therethrough in serial flow relation.
